(19) United States
(12) Patent Application Publication
(10) Pub. No.: US 2017/0157464 A1
(43) Pub. Date: Jun. 8, 2017

(54) INFORMATION PROVIDING METHOD, INFORMATION PROVIDING DEVICE, INFORMATION PROVIDING SYSTEM, AND INFORMATION PROVIDING PROGRAM

(71) Applicant: SEIKO EPSON CORPORATION, Tokyo (JP)

(72) Inventor: Yoichi NATORI, Matsumoto-shi (JP)

(73) Assignee: SEIKO EPSON CORPORATION, Tokyo (JP)

(21) Appl. No.: 15/116,951

(22) PCT Filed: Mar. 27, 2015
(86) PCT No.: PCT/JP2015/001785

§ 371 Date: Aug. 5, 2016

(30) Foreign Application Priority Data
Mar. 28, 2014 (JP) 2014-068320

(51) Int. Cl. A63B 24/00; A63B 69/36; A63B 71/06; G09B 19/00

(52) U.S. Cl. CPC A63B 24/0003; G09B 19/0038; A63B 69/36; A63B 71/06

(57) ABSTRACT

An information providing method includes: a physical characteristic information acquisition process of acquiring first physical characteristic information that is information about a physical characteristic of a user; a swing information acquisition process of acquiring, from a detection device which detects a movement in which the user swings a sporting apparatus, first swing information that is information about the swing by the user; an extraction process of extracting, from a storage device that stores other user information in which second physical characteristic information that is information about a physical characteristic of another user and second swing information that is information about a swing by the another user are associated with each other, the other user information on the basis of the first physical characteristic information and the first swing information; and an output process of outputting the other user information that is extracted.

### TECHNICAL FIELD

The present invention relates to an information providing method, an information providing device, an information providing system, and an information providing program.

### BACKGROUND ART

There are various sports involving a movement in which a player swings a sporting apparatus, such as golf, tennis, table tennis, baseball, and softball. Acquiring the skill of achieving an ideal swing of the sporting apparatus is considered to be important element in improving in these sports.

PTL 1 discloses a golf swing lesson system in which a client device and a server device are connected together in a way that enables communication and in which lesson data of golf swings is transmitted to the client device from the server device in response to a request from the client device.

### CITATION LIST

### Patent Literature

PTL 1: JP-A-2001-296799

### SUMMARY OF INVENTION

### Technical Problem

There are cases where the user wants to compare the user's own swing with other people's swings and use the comparison as a reference to improve the user's own swing. In the golf swing lesson system of PTL 1, information about an instructor's swing can be provided. However, if there is a large difference in physical characteristics and skills, it is often difficult to use the comparison as a reference.

The invention has been made in view of the technical problems as described above. According to some aspects of the invention, there can be provided an information providing method, an information providing device, an information providing system and an information providing program that can provide the user with useful information for improving the movement in which the user swings the sporting apparatus.

### Solution to Problem

The invention has been made to solve at least a part of the problems described above, and he invention can be implemented as the following forms or application examples.

### Application Example 1

An information providing method according to this embodiment is directed to an information providing method including: a physical characteristic information acquisition process of acquiring first physical characteristic information that is information about a physical characteristic of a user; a swing information acquisition process of acquiring, from a detection device which detects a movement in which the user swings a sporting apparatus, first swing information that is information about the swing by the user; an extraction process of extracting, from a storage device that stores other user information in which second physical characteristic information that is information about a physical characteristic of another user and second swing information that is information about a swing by the another user are associated with each other, the other user information on the basis of the first physical characteristic information and the first swing information; and an output process of outputting the other user information that is extracted.

The sporting apparatus is an apparatus used to hit a ball, for example, a golf club, tennis racket, table tennis racket, baseball bat, softball bat, or hockey stick.

According to this application example, the other user information is extracted on the basis of the first physical characteristic information, which is the information about the physical characteristic information of the user, and the first swing information, which is the information about the swing by the user. Therefore, an information providing method that can provide the user with useful information for improving the movement in which the user swings the sporting apparatus can be realized.

### Application Example 2

In the information providing method described above, in the extraction process, the other user information may be extracted on the basis of a degree of similarity between the first physical characteristic information and the second physical characteristic information.

According to this application example, the other user information is extracted on the basis of the degree of similarity between the first physical characteristic information, which is the information about the physical characteristic of the user, and the second physical characteristic information, which is the information about the physical characteristic of the another user. Therefore, for example, the information of another user having a similar physical characteristic to the user can be extracted. Thus, an information providing method that can provide the user with useful information for improving the movement in which the user swings the sporting apparatus can be realized.

### Application Example 3

The information providing method described above may further include a calculation process of calculating an indicator of the swing on the basis of the first swing information.

According to this application example, the indicator of the swing by the user can be provided to the user. Therefore, an information providing method that can provide the user with useful information for improving the movement in which the user swings the sporting apparatus can be realized.

### Application Example 4

In the information providing method described above, in the calculation process, a plurality of types of the indicators may be calculated and indicator selection information for selecting at least one of the indicators may be acquired. In the extraction process, the other user information may be extracted on the basis of the indicator selection information.

According to this application example, since the other user information is extracted on the basis of the indicator selection information for selecting at least one of the indicators, for example, information can be extracted according to the indicator to which the user wants to pay attention. Therefore, an information providing method that can provide the user with useful information for improving the movement in which the user swings the sporting apparatus can be realized.

### Application Example 5

The information providing method described above may further include a skill information acquisition process of acquiring first skill information that is information about a swing skill of the user. The other user information may further include second skill information that is information about a swing skill of the another user. In the extraction process, the other user information may be extracted on the basis of the first skill information.

According to this application example, since the other user information is extracted on the basis of the first skill information, which is the information about the swing skill of the user, for example, information of another user having a similar swing skill to the user can be extracted. Therefore, an information providing method that can provide the user with useful information for improving the movement in which the user swings the sporting apparatus can be realized.

### Application Example 6

The information providing method described above may further include a sporting apparatus information acquisition process of acquiring first sporting apparatus information that is information about the sporting apparatus used by the user. The other user information may further include sporting apparatus information that is information about a sporting apparatus used by the another user. In the extraction process, the other user information may be extracted on the basis of the first sporting apparatus information.

According to this application example, since the other user information is extracted on the basis of the first sporting apparatus information, which is the information about the sporting apparatus used by the user, for example, information according to the sporting apparatus can be extracted. Therefore, an information providing method that can provide the user with useful information for improving the movement in which the user swings the sporting apparatus can be realized.

### Application Example 7

An information providing device according to this embodiment is directed to an information providing device including: a physical characteristic information acquisition unit which acquires first physical characteristic information that is information about a physical characteristic of a user; a swing information acquisition unit which acquires, from a detection device which detects a movement in which the user swings a sporting apparatus, first swing information that is information about the swing by the user; an extraction unit which extracts, from a storage device that stores other user information in which second physical characteristic information that is information about a physical characteristic of another user and second swing information that is information about a swing by the another user are associated with each other, the other user information on the basis of the first physical characteristic information and the first swing information; and an output unit which outputs the other user information that is extracted.

According to this application example, the other user information is extracted on the basis of the first physical characteristic information, which is the information about the physical characteristic information of the user, and the first swing information, which is the information about the swing by the user. Therefore, an information providing device that can provide the user with useful information for improving the movement in which the user swings the sporting apparatus can be realized.

### Application Example 8

An information providing system according to this embodiment is directed to an information providing system including: the information providing device described above; and the detection device.

According to this application example, the system includes the information providing device which extracts the other user information on the basis of the first physical characteristic information, which is the information about the physical characteristic information of the user, and the first swing information, which is the information about the swing by the user. Therefore, an information providing system that can provide the user with useful information for improving the movement in which the user swings the sporting apparatus can be realized.

### Application Example 9

An information providing program according to this embodiment is directed to an information providing program causing a computer to execute: a procedure of acquiring first physical characteristic information that is information about a physical characteristic of a user; a procedure of acquiring, from a detection device which detects a movement in which the user swings a sporting apparatus, first swing information that is information about the swing by the user; a procedure of extracting, from a storage device that stores other user information in which second physical characteristic information that is information about a physical characteristic of another user and second swing information that is information about a swing by the another user are associated with each other, the other user information on the basis of the first physical characteristic information and the first swing information; and a procedure of outputting the other user information that is extracted.

According to this application example, the other user information is extracted on the basis of the first physical characteristic information, which is the information about the physical characteristic information of the user, and the first swing information, which is the information about the swing by the user. Therefore, an information providing program that can provide the user with useful information for improving the movement in which the user swings the sporting apparatus can be realized.

### BRIEF DESCRIPTION OF DRAWINGS

FIG. 1 is a diagram for explaining the outline of an information providing system 000 according to an embodiment.

FIG. 2 is a diagram showing an example of the installation position and direction of a detection device 1.

FIG. 3 is a block diagram showing an example of the configuration of the information providing system 1000 according to the embodiment.

FIG. 4 is a flowchart showing the outline of an information providing method according to the embodiment.

FIG. 5 is a table showing an example of other user information stored in a storage device 310.

FIG. 6 is a diagram showing an example of display of other user information that is extracted.

### DESCRIPTION OF EMBODIMENTS

Hereinafter, a preferred embodiment of the invention will be described with reference to the drawings. The drawings used here are presented as a matter of convenience for explanation. It should be noted that the embodiment below is not intended to unduly limit the content of the invention described in the appended claims. In addition, not all the configurations described below are essential components of the invention.

Hereinafter, a movement in which a user swings a golf club (an example of a sporting apparatus) will be described as an example.

### 1. Information Providing Device, Information Providing System, and Information Providing Program

### 1-1. Outline of Information Providing System

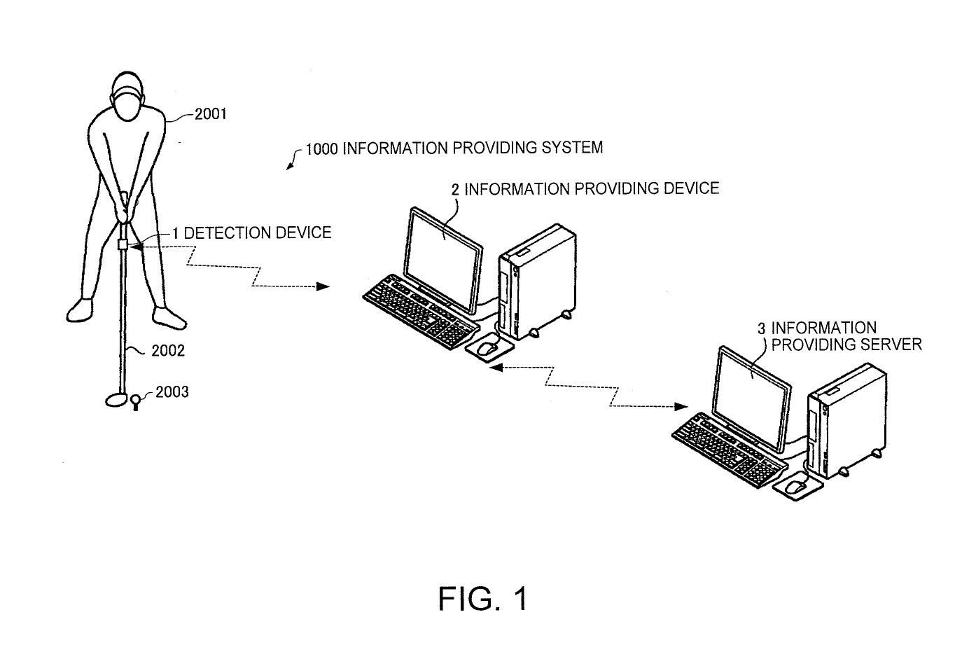

FIG. 1 is a diagram for explaining the outline of an information providing system 1000 according to this embodiment. The information providing system 1000 according to this embodiment includes a detection device 1, an information providing device 2, and an information providing server 3.

The detection device 1 detects a movement in which a user 2001 swings a golf club 2002 (an example of a sporting apparatus).

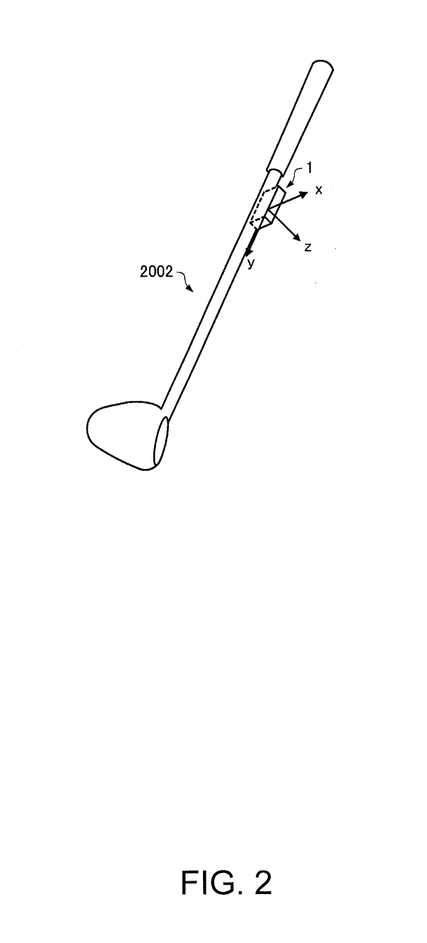

FIG. 2 is a diagram showing an example of the installation position and direction of the detection device 1. The detection device 1 is capable of measuring an acceleration generated in each of three axial directions and an angular velocity generated around each of the three axes, and is installed on the golf club 2002.

In this embodiment, the detection device 1 is mounted at a part of the shaft of the golf club 2002 in such a way that one of the three detection axes (x-axis, y-axis, z-axis), for example, the y-axis is placed in line with the longitudinal direction of the shaft, as shown in FIG. 2. Preferably, the detection device 1 is mounted at a position close to a grip portion which an impact at the time of ball hitting does not easily reach and to which a centrifugal force is not applied at the time of a swing. The shaft is a stick portion excluding the head of the golf club 2002 and including the grip portion.

The user 2001 makes a swing movement in which the user hits a golf ball 2003, according to predetermined procedures.

The information providing device 2 carries out various calculations related to the movement in which the user 2001 swings the golf club 2002 (sporting apparatus), using data detected by the detection device 1. The information providing device 2 also extracts and outputs data from the information providing server 3 on the basis of the results of the calculations.

The information providing server 3 includes a storage device 310 (described below) which stores other user information (described below) about a plurality of other users.

It should be noted that the communication between the information providing device 2 and the detection device 1 may be wireless communication or wired communication. In addition, the communication between the information providing device 2 and the information providing server 3 may be wireless communication or wired communication.

### 1-2. Configuration of Information Providing System

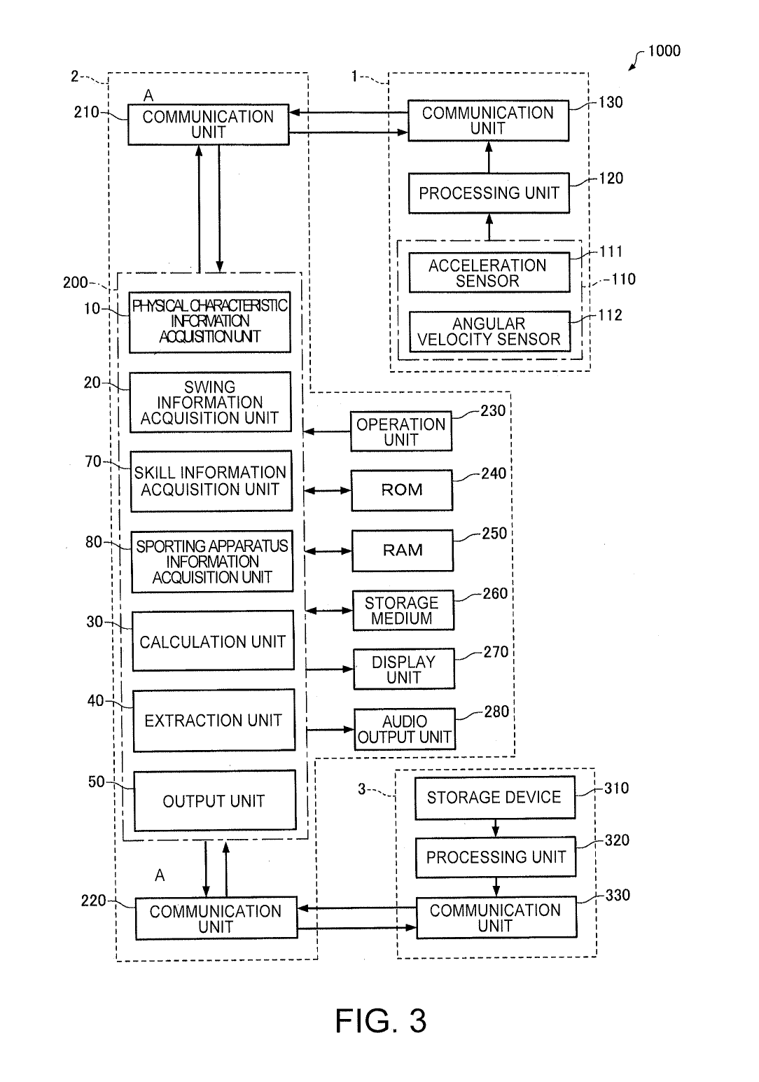

FIG. 3 is a block diagram showing an example of the configuration of the information providing system 1000 according to this embodiment.

The detection device 1 according to this embodiment includes a detection unit 110, a processing unit 120, and a communication unit 130.

The detection unit 110 may include, for example, an inertial sensor. The inertial sensor is a sensor which detects a physical quantity, physical phenomenon or the like (acceleration, angle of inclination, impact, oscillation, rotation or the like), using inertia. As the inertial sensor, for example, an acceleration sensor, angular velocity sensor or the like can be employed. In the embodiment, the detection unit 110 includes an acceleration sensor 111 and an angular velocity sensor 112.

The acceleration sensor 111 measures an acceleration generated in each of three axial directions that intersect with each other (ideally orthogonal to each other), and outputs a digital signal (acceleration data) corresponding to the magnitudes and directions of the accelerations on the three axes that are measured.

The angular velocity sensor 112 measures an angular velocity generated around each of three axes that intersect with each other (ideally orthogonal to each other), and outputs a digital signal (angular velocity data) corresponding to the magnitudes and directions of the angular velocities on the three axes that are measured.

The processing unit 120 receives the acceleration data and the angular velocity data from the acceleration sensor 111 and the angular velocity sensor 112, respectively, then adds time information thereto, stores these data in a storage unit, not shown, adds time information to the stored measured data (acceleration data and angular velocity data), generates packet data according to a communication format, and outputs the packet data to the communication unit 130.

Ideally, the acceleration sensor 111 and the angular velocity sensor 112 should be installed in the detection device 1 in such a way that the three axes of each of the sensors coincide with the three axes (x-axis, y-axis, z-axis) of an orthogonal coordinate system (sensor coordinate system) defined for the detection device 1. However, in practice, there is a discrepancy in the angle of installation. Thus, the processing unit 120 carries out processing to convert the acceleration data and the angular velocity data to data in the xyz coordinate system, using a correction parameter that is calculated in advance according to the discrepancy in the angle of installation.

The processing unit 120 also carries out temperature correction processing of the acceleration sensor 111 and the angular velocity sensor 112. It should be note that the temperature correction function may be incorporated in the acceleration sensor 111 and the angular velocity sensor 112.

It should be noted that the acceleration sensor 111 and the angular velocity sensor 112 may be configured to output an analog signal. In this case, the processing unit 120 may perform A/D conversion of the output signal from the acceleration sensor 111 and the output signal from the angular velocity sensor 112, thus generate measured data (acceleration data and angular velocity data), and generates packet data for communication, using these measured data.

The communication unit 130 carries out processing to transmit the packet data received from the processing unit 120 to the information providing device 2 as motion information that is information about a swing by the user 2001 swinging the sporting apparatus (golf club 2002), and processing to receive a control command from the information providing device 2 and send the control command to the processing unit 120, and the like. The processing unit 120 carries out various kinds of processing according to the control command.

The information providing device 2 according to this embodiment includes a processing unit 200, a communication unit 210, a communication unit 220, an operation unit 230, a ROM 240, a RAM 250, a storage medium 260, a display unit 270, and an audio output unit 280. The information providing device 2 may be for example, a personal computer (PC) or a mobile device such as a smartphone.

The communication unit 210 carries out processing to receive packet data transmitted from the detection device 1 and send the packet data to the processing unit 200, and processing to transmit a control command from the processing unit 200 to the detection device 1, and the like.

The communication unit 220 carries out processing to receive packet data transmitted from the information providing server 3 and send the packet data to the processing unit 200, and processing to transmit a control command from the processing unit 200 to the information providing server 3, and the like.

The operation unit 230 carries out processing to acquire operation data from the user and send the operation data to the processing unit 200. The operation unit 230 may be, for example, a touch panel display, buttons, keys, a microphone, and the like.

The ROM 240 stores a program for the processing unit 200 to carry out various kinds of calculation processing and control processing, and various programs, data and the like for realizing an application function.

The ROM 250 is a storage unit which is used as a work area for the processing unit 200 and which temporarily stores programs and data read out from the ROM 240, data inputted from the operation unit 230, the results of calculations executed by the processing unit 200 according to various programs, and the like.

The storage medium 260 is a non-volatile storage unit which stores data that needs long-term saving, of the data generated through the processing by the processing unit 200. The storage medium 260 may also store a program for the processing unit 200 to carry out various kinds of calculation processing and control processing, and various programs, data and the like for realizing an application function.

The display unit 270 displays the result of processing by the processing unit 200, in the form of letters, a graph, a table, an animation, or other images. The display unit 270 may be, for example, a CRT, LCD, touch panel display, HMD (head mounted display), or the like. It should be noted that the functions of the operation unit 230 and the display unit 270 may be realized by a single touch panel display.

The audio output unit 280 outputs the result of processing by the processing unit 200 in the form of a sound such as a voice or beep. The audio output unit 280 may be, for example, a speaker, buzzer, or the like.

The processing unit 200 carries out processing to transmit a control command to the detection device 1 and the information providing server 3, various kinds of calculation processing on data received from the detection device 1 via the communication unit 210, various kinds of calculation processing on data received from the information providing server 3 via the communication unit 220, and other various kinds of control processing, according to a program stored in the ROM 240 or the storage medium 260, or according to a program received from a server via a network and stored in the RAM 250 or the storage medium 260.

Particularly, in this embodiment, the processing unit 200 executes the program in question (information providing program) and thereby functions as a physical characteristic information acquisition unit 10, a swing information acquisition unit 20, a calculation unit 30, an extraction unit 40, an output unit 50, a skill information acquisition unit 70, and a sporting apparatus information acquisition unit 80. The information providing program may be realized as a program that causes a computer to execute a procedure carried out by at least one of the physical characteristic information acquisition unit 10, the swing information acquisition unit 20, the calculation unit 30, the extraction unit 40, the output unit 50, the skill information acquisition unit 70, and the sporting apparatus information acquisition unit 80.

The physical characteristic information acquisition unit 10 acquires first physical characteristic information that is information about a physical characteristic of the user 2001. The physical characteristic information acquisition unit 10 may acquire the first physical characteristic information, for example, from the operation unit 230, or may also acquire the first physical characteristic information from the RAM 250 or the storage medium 260. As the first physical characteristic information, for example, the gender, height, weight, age, country of origin, experience in golfing and the like of the user 2001 can be employed.

The swing information acquisition unit 20 acquires first swing information that is information about a swing by the user, from the detection device 1 detecting the movement in which the user 2001 swings the sporting apparatus (golf club 2002) (hereinafter, simply referred to as a “swing” in some cases). In this embodiment, the swing information acquisition unit 20 acquires the first swing information from the detection device 1 via the communication unit 210.

The calculation unit 30 calculates an indicator related to the swing by the user 2001 on the basis of the first swing information acquired by the swing information acquisition unit 20. As the indicator related to the swing, for example, a maximum value of the head speed during the swing period, a maximum value of the grip speed during the swing period, the timing when the grip speed reaches a maximum value with reference to the timing of impact (grip deceleration timing), the amount of change in the rotation angle of the shaft axis during the swing period (shaft rotation) or the like can be employed.

According to this embodiment, the indicator related to the swing by the user can be provided to the user. Therefore, the information providing device 2 that can provide the user with useful information for improving the movement in which the user swings the sporting apparatus can be realized.

The calculation unit 30 may calculate a plurality of types of indicators. The calculation unit 30 may also perform statistical processing (for example, averaging) on the first swing information corresponding to a plurality of swings and thus calculate the indicator. The calculation unit 30 may acquire indicator selection information for selecting at least one of the indicators to be calculated. The calculation unit 30 may acquire the indicator selection information, for example, from the operation unit 230.

The extraction unit 40 extracts other user information from the storage device 310 which stores other user information in which second physical characteristic information that is information about a physical characteristic of another user (different user from the user 2001) and second swing information that is information about a swing by the another user are associated with each other, on the basis of the first physical characteristic information acquired by the physical characteristic information acquisition unit 10 and the first swing information acquired by the swing information acquisition unit 20. In this embodiment, the other user information is extracted and acquired from the storage device 310 of the information providing server 3 via the communication unit 220.

The output unit 50 outputs the other user information extracted by the extraction unit 40. The output unit 50 may, for example, process the other user information extracted by the extraction unit 40 and then output the processed other user information to the display unit 270.

According to this embodiment, the other user information is extracted on the basis of the first physical characteristic information, which is the information about the physical characteristic of the user, and the first swing information, which is the information about the swing by the user. Therefore, the information providing device 2 that can provide the user 2001 with useful information for improving the movement in which the user swings the sporting apparatus (golf club 2002) can be realized.

The extraction unit 40 may extract the other user information from the storage device 310 on the basis of the degree of similarity between the first physical characteristic information and the second physical characteristic information. The extraction unit 40 may determine the degree of similarity between the first physical characteristic information of the user 2001 and the second physical characteristic information included in the other user information stored in the storage device 310, for example, on the basis of whether the genders coincide with each other or not, whether the difference in height is within a reference range or not, whether the difference in weight is within a reference range or not, or two or more of these. The extraction unit 40 may preferentially extract the other user information including the second physical characteristic information with a high degree of similarity with the first physical characteristic information.

According to this embodiment, since the other user information is extracted on the basis of the degree of similarity between the first physical characteristic information and the second physical characteristic information, for example, the information of another user having a similar physical characteristic to the user 2001 can be extracted. Therefore, the information providing device 2 that can provide the user 2001 with useful information for improving the movement in which the user swings the sporting apparatus (golf club 2002) can be realized.

The extraction unit 40 may extract the other user information from the storage device 310 on the basis of selection information acquired by the calculation unit 30. For example, if the calculation unit 30 acquires information for selecting the indicator of the “maximum value of the head speed during the swing period” as the selection information, the extraction unit 40 may preferentially extract the other user information in which the “maximum value of the head speed during the swing period” is higher than that of the user 2001 by a predetermined rate.

According to the embodiment, since the other user information is extracted on the basis of the indicator selection information for selecting at least one of the indicators, for example, information can be extracted according to the indicator to which the user 2001 wants to pay attention. Therefore, the information providing device 2 that can provide the user 2001 with useful information for improving the movement in which the user swings the sporting apparatus (golf club 2002) can be realized.

The skill information acquisition unit 70 acquires first skill information that is information about the swing skill of the user 2001. The skill information acquisition unit 70 may acquire the first skill information, for example, from the operation unit 230, or may acquire the first skill information from the RAM 250 or the storage medium 260. As the first skill information, for example, information that gives a criterion of the degree of swing skill, such as handicap or scores in the course. It should be noted that, in the embodiment, second skill information that is information about the swing skill of another user is associated with the second physical characteristic information and the second swing information and thus included in the other user information stored in the storage device 310.

The extraction unit 40 may extract the other user information from the storage device 310 on the basis of the first skill information acquired by the skill information acquisition unit 70. For example, the extraction unit 40 may preferentially extract the other user information including the second skill information that is higher by a predetermined value than the first skill information acquired by the skill information acquisition unit 70. Also, the extraction unit 40 may preferentially extract, for example, the other user information including the second skill information that is lower by a predetermined value than the first skill information acquired by the skill information acquisition unit 70. Moreover, the extraction unit 40 may preferentially extract, for example, the other user information including the second skill information that falls within a predetermined range from the first skill information acquired by the skill information acquisition unit 70.

According to the embodiment, since the other user information is extracted on the basis of the first skill information, which is the information about the swing skill of the user 2001, for example, the information about another user having a similar swing skill to the user 2001 can be extracted. Therefore, the information providing device 2 that can provide the user 2001 with useful information for improving the movement in which the user swings the sporting apparatus (golf club 2002) can be realized.

The sporting apparatus information acquisition unit 80 acquires first sporting apparatus information that is information about the sporting apparatus (golf club 2002) used by the user 2001. The sporting apparatus information acquisition unit 80 may acquire the first sporting apparatus information, for example, from the operation unit 230, or may acquire the sporting apparatus information from the RAM 250 or the storage medium 260. As the first sporting apparatus information, for example, the club number, manufacturer, model number or the like of the golf club 2002 can be employed. It should be noted that, in this embodiment, second sporting apparatus information that is information about a sporting apparatus used by another user is associated with the second physical characteristic information and the second swing information and thus included in the other user information stored in the storage device 310.

The extraction unit 40 may extract the other user information from the storage device 310 on the basis of the first sporting apparatus information acquired by the sporting apparatus information acquisition unit 80. For example, the extraction unit 40 may preferentially extract the other user information including the second sporting apparatus information having the club number that coincides with the club number of the first sporting apparatus information. Also, the extraction unit 40 may preferentially extract, for example, the other user information including the second sporting apparatus information having the club number and manufacturer that coincide with those of the first sporting apparatus information.

According to this embodiment, since the other user information is extracted on the basis of the first sporting apparatus information, which is the information about the sporting apparatus (golf club 2002) used by the user, for example, information corresponding to the sporting apparatus (golf club 2002) can be extracted. Therefore, the information providing device 2 that can provide the user 2001 with useful information for improving the movement in which the user swings the sporting apparatus (golf club 2002) can be realized.

Also, according to the information providing program of this embodiment, the other user information is extracted on the basis of the first physical characteristic information, which is the information about the physical characteristic of the user, and the first swing information, which is the information about the swing by the user. Therefore, the information providing program that can provide the user 2001 with useful information for improving the movement in which the user swings the sporting apparatus (golf club 2002) can be realized.

Moreover, according to the information providing system 1000 of this embodiment, the system includes the information providing device 2 which extracts the other user information on the basis of the first physical characteristic information, which is the information about the physical characteristic of the user, and the first swing information, which is the information about the swing by the user. Therefore, the information providing system 1000 that can provide the user 2001 with useful information for improving the movement in which the user swings the sporting apparatus (golf club 2002) can be realized.

### 2. Information Providing Method

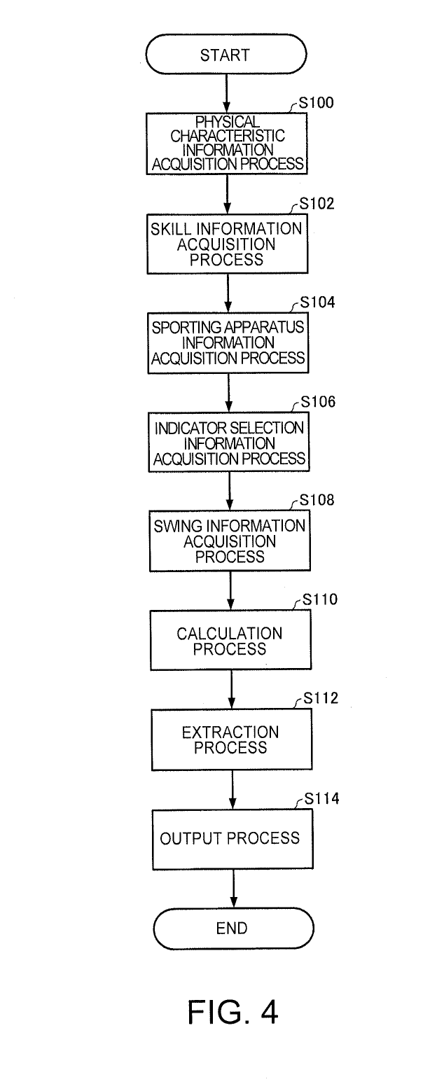

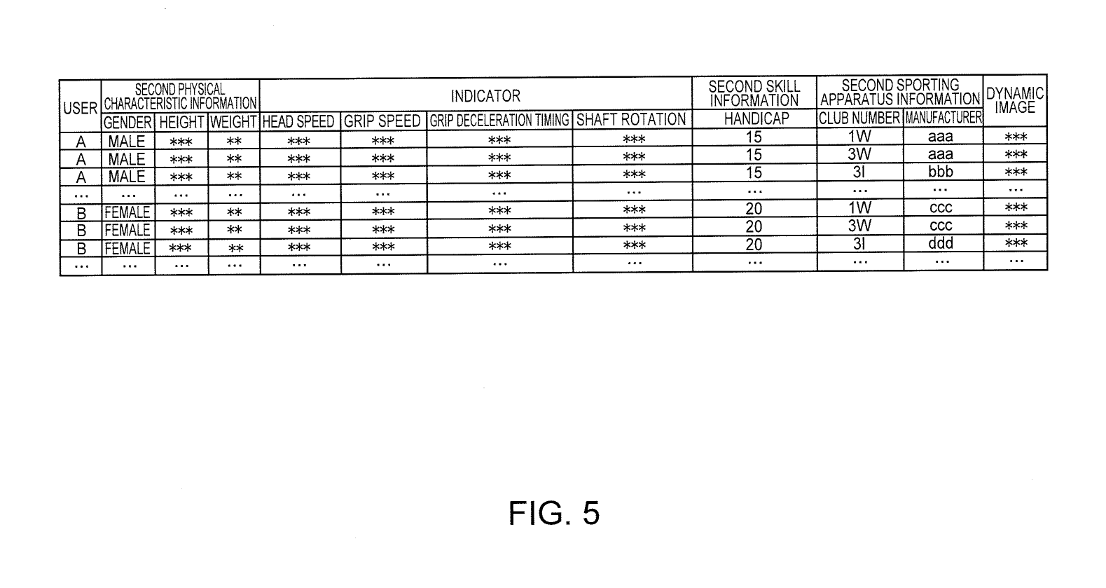

FIG. 4 is a flowchart showing the outline of an information providing method according to this embodiment. Not all the processes shown in FIG. 4 are essential components. FIG. 5 is a table showing an example of the other user information storage in the storage device 310. In FIG. 5, the item of “head speed” shows the maximum speed of the head speed during the swing period. The item of “grip speed” shows the maximum value of the grip speed during the swing period. The item of “grip deceleration timing” shows the timing when the grip speed reaches the maximum value with reference to the timing of impact. The item of “shaft rotation” shows the amount of change in the rotation angle of the shaft axis during the swing period. The example shown in FIG. 5 also includes dynamic image data produced by filming the swing movement of the user at the time of generating the second swing information that serves as a basis for calculating the indicator included in the other user information. Hereinafter, an example in which the information providing method according to the embodiment is carried out using the information providing system 1000 will be described.

The information providing method according to the embodiment includes a physical characteristic information acquisition process (Step S100), a swing information acquisition process (Step S108), an extraction process (Step S112), and an output process (Step S114). The information providing method according to the embodiment may further include a skill information acquisition process (Step S102), a sporting apparatus information acquisition process (Step S104), and an indicator selection information acquisition process (Step S106).

In the example shown in FIG. 4, first, the physical characteristic information acquisition process (Step S100) of acquiring the first physical characteristic information, which is the information about the physical characteristic of the user 2001, is carried out. In the embodiment, the physical characteristic information acquisition unit 10 carries out the processing of Step S100. Also, in the embodiment, information about the gender, height and weight of the user 2001 is acquired as the first physical characteristic information.

In the example shown in FIG. 4, after Step S100, the skill information acquisition process (Step S102) of acquiring the first skill information, which is the information about the swing skill of the user 2001, is carried out. In the embodiment, the skill information acquisition unit 70 carries out the processing of Step S102. Also, in the embodiment, information about the handicap of the user 2001 is acquired as the first skill information.

In the example shown in FIG. 4, after Step S102, the sporting apparatus information acquisition process (Step S104) of acquiring the first sporting apparatus information, which is the information about the sporting apparatus (golf club 2002) used by the user 2001, is carried out. In the embodiment, the sporting apparatus information acquisition unit 80 carries out the processing of Step S104. Also, in the embodiment, information about the club number and manufacturer of the golf club 2002 is acquired as the first sporting apparatus information.

In the example shown in FIG. 4, after Step S104, the indicator selection information acquisition process (Step S106) of acquiring the indicator selection information for selecting at least one indicator of a plurality of types of indicators calculated in a calculation process (Step S110) is carried out. In the embodiment, the calculation unit 30 carries out the processing of Step S106. Also, in the embodiment, for example, information about the “maximum value of the head speed during the swing period” is acquired as the indicator selection information.

In the example shown in FIG. 4, after Step S106, the swing information acquisition process (Step S108) of acquiring the first swing information, which is the information about the swing by the user 2001, from the detection device 1 detecting the movement in which the user 2001 swings the sporting apparatus (golf club 2002), is carried out. In the embodiment, the swing information acquisition unit 20 carries out the processing of Step S108. Also, in the embodiment, information based on the results of detection by the acceleration sensor 111 and the angular velocity sensor 112 is acquired as the first swing information.

In the example shown in FIG. 4, after Step S108, the calculation process (Step S110) of calculating the indicator about the swing by the user 2001 on the basis of the first swing information acquired in Step S108 is carried out. In the embodiment, the calculation unit 30 carries out the processing of Step S110. Also, in the embodiment, four indicators, that is, the maximum value of the head speed during the swing period, the maximum value of the grip speed during the swing period, the timing when the grip speed reaches the maximum value with reference to the timing of impact (grip deceleration timing), and the amount of change in the rotation angle of the shaft axis during the swing period (shaft rotation), are calculated as the indicators of the swing.

According to this embodiment, the indicator about the swing by the user 2001 can be provided to the user 2001. Therefore, the information providing method that can provide the user 2001 with useful information for improving the movement in which the user swings the sporting apparatus (golf club 2002) can be realized.

In the example shown in FIG. 4, after Step S110, the extraction process (Step S112) is carried out, in which the other user information is extracted from the storage device 310 storing the other user information in which the second physical characteristic information, which is the information about the physical characteristic of another user, and the second swing information, which is the information about the swing by the another user, are associated with each other, on the basis of the first physical characteristic information acquired in Step S100 and the first swing information acquired in Step S108. In the embodiment, the extraction unit 40 carries out the processing of Step S112. The extraction unit 40 may extract one or a plurality of data from the other user information shown in FIG. 5.

In the example shown in FIG. 4, after Step S112, the output process (Step S114) of outputting the other user information extracted in Step S112 is carried out. In the embodiment, the output unit 50 carries out the processing of Step S114. Also, in the embodiment, the output unit 50 displays the extracted other user information on the display unit 270. The output unit 50 may also combine the indicator calculated in the calculation process (Step S110) and the indicator of the other user information extracted in the extraction process (Step S112) and thus output the combined indicators. In addition, if the other user information includes dynamic image data, the output unit 50 may play back and display the dynamic image data.

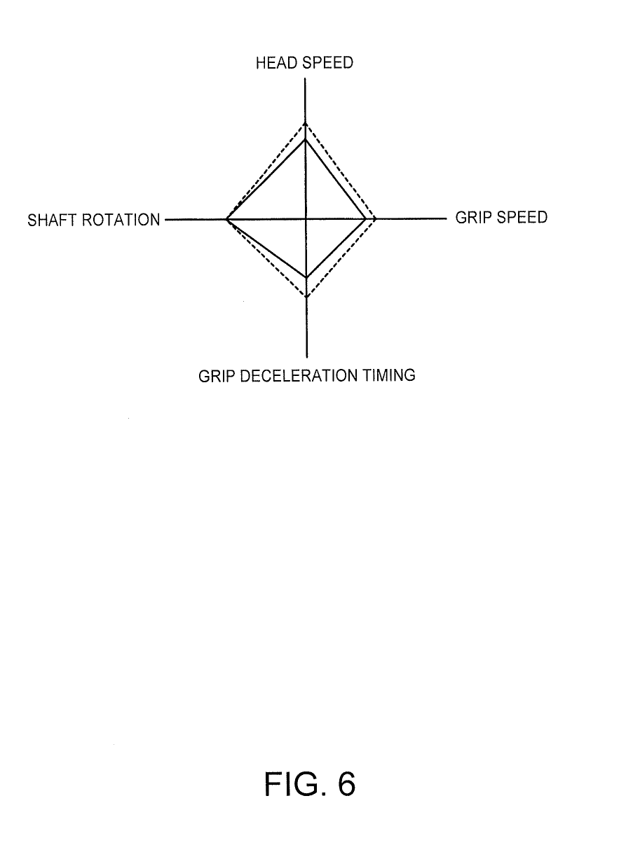

FIG. 6 is a diagram showing an example of display of the extracted other user information. In the radar chart shown in FIG. 6, the item of “head speed” shows the maximum value of the head speed during the swing period. The item of “grip speed” shows the maximum value of the grip speed during the swing period. The item of “grip deceleration timing” shows the timing when the grip speed reaches the maximum value with reference to the timing of impact. The item of “shaft rotation” shows the amount of change in the rotation angle of the shaft axis during the swing period. Further, in the example shown in FIG. 6, the indicator calculated in the calculation process (Step S110) is indicated by a solid line, and the indicator of the other user information extracted in the extraction process (Step S112) is indicated by a dashed line.

According to the embodiment, the other user information is extracted on the basis of the first physical characteristic information, which is the information about the physical characteristic of the user, and the first swing information, which is the information about the swing by the user. Therefore, the information providing method that can provide the user 2001 with useful information for improving the movement in which the user swings the sporting apparatus (golf club 2002) can be realized.

In the information providing method described above, in the extraction process (Step S112), the other user information may be extracted on the basis of the degree of similarity between the first physical characteristic information and the second physical characteristic information. For example, the degree of similarity between the first physical characteristic information of the user 2001 and the second physical characteristic information included in the other user information stored in the storage device 310 may be determined on the basis of whether the genders coincide with each other or not, whether the difference in height is within a reference range or not, whether the difference in weight is within a reference range or not, or two or more of these. Also, the other user information including the second physical characteristic information with a high degree of similarity with the first physical characteristic information may be extracted preferentially.

According to this embodiment, since the other user information is extracted on the basis of the degree of similarity between the first physical characteristic information and the second physical characteristic information, for example, the information of another user having a similar physical characteristic to the user 2001 can be extracted. Therefore, the information providing method that can provide the user 2001 with useful information for improving the movement in which the user swings the sporting apparatus (golf club 2002) can be realized.

In the information providing method described above, in the extraction process (Step S112), the other user information may be extracted from the storage device 310 on the basis of the selection information acquired in the indicator selection information acquisition process (Step S106). For example, if information for selecting the indicator of the “maximum value of the head speed during the swing period” is acquired as the selection information in the indicator selection information acquisition process (Step S106), the other user information in which the “maximum value of the head speed during the swing period” is higher than that of the user 2001 by a predetermined rate may be extracted preferentially in the extraction process (Step S112).

According to the embodiment, since the other user information is extracted on the basis of the indicator selection information for selecting at least one of the indicators, for example, information can be extracted according to the indicator to which the user 2001 wants to pay attention. Therefore, the information providing method that can provide the user 2001 with useful information for improving the movement in which the user swings the sporting apparatus (golf club 2002) can be realized.

In the information providing method described above, in the extraction process (Step S112), the other user information may be extracted from the storage device 310 on the basis of the first skill information acquired in the skill information acquisition process (Step S102). For example, in the extraction process (Step S112), the other user information including the second skill information that is higher by a predetermined value than the first skill information acquired in the skill information acquisition process (Step S102) may be extracted preferentially. Also, in the extraction process (Step S112), for example, the other user information including the second skill information that is lower by a predetermined value than the first skill information acquired in the skill information acquisition process (Step S102) may be extracted preferentially. Moreover, in the extraction process (Step S112), for example, the other user information including the second skill information that falls within a predetermined range from the first skill information acquired in the skill information acquisition process (Step S102) may be extracted preferentially.

According to the embodiment, since the other user information is extracted on the basis of the first skill information, which is the information about the swing skill of the user 2001, for example, the information about another user having a similar swing skill to the user 2001 can be extracted. Therefore, the information providing method that can provide the user 2001 with useful information for improving the movement in which the user swings the sporting apparatus (golf club 2002) can be realized.

In the information providing method described above, in the extraction process (Step S112), the other user information may be extracted from the storage device 310 on the basis of the first sporting apparatus information acquired in the sporting apparatus information acquisition process (Step S104). For example, in the extraction process (Step S112), the other user information including the second sporting apparatus information having the club number that coincides with the club number of the first sporting apparatus information may be extracted preferentially. Also, in the extraction process (Step S112), for example, the other user information including the second sporting apparatus information having the club number and manufacturer that coincide with those of the first sporting apparatus information may be extracted preferentially.

According to this embodiment, since the other user information is extracted on the basis of the first sporting apparatus information, which is the information about the sporting apparatus (golf club 2002) used by the user, for example, information corresponding to the sporting apparatus (golf club 2002) can be extracted. Therefore, the information providing method that can provide the user 2001 with useful information for improving the movement in which the user swings the sporting apparatus (golf club 2002) can be realized.

It should be notes that, in the flow shown in FIG. 4, the extraction process (Step S112) has only to be carried out before the output process (Step S114). Also, the swing information acquisition process (Step S108) has only to be carried out before the calculation process (Step S110). Further, the physical characteristic information acquisition process (Step S100), the skill information acquisition process (Step S102), the sporting apparatus information acquisition process (Step S104), and the indicator selection information acquisition process (Step S106) have only to be carried out before the extraction process (Step S112). Each process shown in FIG. 4 can be arbitrarily replaced by another process in the order within the range that satisfies the above requirements.

The embodiments and modifications above are simply examples and not limiting. For example, the respective embodiments and modifications can be combined according to need.

The invention includes substantially the same configurations as the configurations described in the embodiments (for example, a configuration having the same function, method and result, or a configuration having the same objective and effect). The invention also includes configurations where non-essential parts of the configurations described in the embodiments are replaced. The invention also includes configurations that achieve the same advantageous effects as the configurations described in the embodiments, or configurations that can achieve the same objectives. Moreover, the invention includes configurations where a known technique is added to the configurations described in the embodiments.

### REFERENCE SIGNS LIST

1: detection device
2: information providing device
3: information providing server
10: physical characteristic information acquisition unit
20: swing information acquisition unit
30: calculation unit
40: extraction unit
50: output unit
70: skill information acquisition unit
80: sporting apparatus information acquisition unit
110: detection unit
111: acceleration sensor
112: angular velocity sensor
130: communication unit
200: processing unit
210, 220: communication unit
230: operation unit
240: ROM
250: RAM
260: storage medium
270: display unit
280: audio output unit
310: storage device
320: processing unit
330: communication unit
1000: information providing system
2001: user
2002: golf club
2003: golf ball

1. An information providing method comprising:
a physical characteristic information acquisition process of acquiring first physical characteristic information that is information about a physical characteristic of a user;
a swing information acquisition process of acquiring, from a detection device which detects a movement in which the user swings a sporting apparatus, first swing information that is information about the swing by the user;
an extraction process of extracting, from a storage device that stores other user information in which second physical characteristic information that is information about a physical characteristic of another user and second swing information that is information about a swing by the another user are associated with each other, the other user information on the basis of the first physical characteristic information and the first swing information; and
an output process of outputting the other user information that is extracted.

2. The information providing method according to claim 1, wherein
in the extraction process, the other user information is extracted on the basis of a degree of similarity between the first physical characteristic information and the second physical characteristic information.

3. The information providing method according to claim 1, further comprising
a calculation process of calculating an indicator of the swing on the basis of the first swing information.

4. The information providing method according to claim 3, wherein
in the calculation process, a plurality of types of the indicators is calculated and indicator selection information for selecting at least one of the indicators is acquired, and
in the extraction process, the other user information is extracted on the basis of the indicator selection information.

5. The information providing method according to claim 1, further comprising
a skill information acquisition process of acquiring first skill information that is information about a swing skill of the user,
wherein the other user information further includes second skill information that is information about a swing skill of the another user, and
in the extraction process, the other user information is extracted on the basis of the first skill information.

6. The information providing method according to claim 1, further comprising
a sporting apparatus information acquisition process of acquiring first sporting apparatus information that is information about the sporting apparatus used by the user,
wherein the other user information further includes sporting apparatus information that is information about a sporting apparatus used by the another user, and
in the extraction process, the other user information is extracted on the basis of the first sporting apparatus information.

7. An information providing device comprising:
a physical characteristic information acquisition unit which acquires first physical characteristic information that is information about a physical characteristic of a user;
a swing information acquisition unit which acquires, from a detection device which detects a movement in which the user swings a sporting apparatus, first swing information that is information about the swing by the user;
an extraction unit which extracts, from a storage device that stores other user information in which second physical characteristic information that is information about a physical characteristic of another user and second swing information that is information about a swing by the another user are associated with each other, the other user information on the basis of the first physical characteristic information and the first swing information; and
an output unit which outputs the other user information that is extracted.

8. An information providing system comprising:
the information providing device according to claim 7; and
the detection device.

9. An information providing program causing a computer to execute:
a procedure of acquiring first physical characteristic information that is information about a physical characteristic of a user;
a procedure of acquiring, from a detection device which detects a movement in which the user swings a sporting apparatus, first swing information that is information about the swing by the user;
a procedure of extracting, from a storage device that stores other user information in which second physical characteristic information that is information about a physical characteristic of another user and second swing information that is information about a swing by the another user are associated with each other, the other user information on the basis of the first physical characteristic information and the first swing information; and
a procedure of outputting the other user information that is extracted.
